(19) United States
(12) Patent Application Publication
(10) Pub. No.: US 2018/0314789 A1
(43) Pub. Date: Nov. 1, 2018

(54) MELT CURVE ANALYSIS

(71) Applicant: THERMO FISHER SCIENTIFIC OY, Vantaa (FI)

(72) Inventors: Tuomo Von Lerber, Espoo (FI); Jaakko Kurkela, Espoo (FI); David Cohen, Espoo (FI)

(21) Appl. No.: 15/905,714

(22) Filed: Feb. 26, 2018

Related U.S. Application Data
(63) Continuation of application No. 14/786,828, filed on Oct. 23, 2015, now abandoned.

(51) Int. Cl. G06F 19/12; G06F 19/24

(52) U.S. Cl. CPC G06F 19/12; G06F 19/20; G06F 19/24

(57) ABSTRACT

A technique for analyzing a melt curve characterizing the melt of a solution comprising one or more populations of nucleic acid molecules and a constant number of fluorophores of at least first type is provided. The technique comprises obtaining a fluorescence signal descriptive of melt curve data over a temperature range, the fluorescence signal representing the intensity of the light emitted by fluorophores of said first type as a function of temperature, modeling the fluorescence signal at a plurality of temperatures within the temperature range as a sum of a first signal component representing the combined light intensity emitted by unbound fluorophores of said first type in the solution at a given temperature and a set of one or more second signal components, each representing the combined light intensity emitted by said fluorophores bound to the respective nucleic acid molecule population at the given temperature, wherein the first signal component is provided as a product of a first term representing the relative number of unbound fluorophores of said first type at the given temperature and a second term representing the emission efficiency of an unbound fluorophore of said first type at said given temperature and wherein each second signal component is provided as a product of a respective third term representing the relative number of said fluorophores bound to the respective nucleic acid molecule population at the given temperature and a respective fourth term representing the emission efficiency of said fluorophore bound to the respective nucleic acid molecule population at said given temperature, and utilizing numerical analysis to determine the values of said first, second, third and fourth terms at said plurality of temperatures such that the difference between the first fluorescence signal and the modeled fluorescence signal meets a predefined criterion

### FIELD OF THE INVENTION

The present invention relates to melt curve analysis. In particular, the present invention relates to a method, to an apparatus and to a computer program for analyzing a signal descriptive of melt curve data.

### BACKGROUND

Melt curve analysis and HRM (high resolution melting) analysis are commonly used methods for detecting and analyzing the presence of nucleic acid sequences in a sample. The analysis is normally performed immediately after PCR amplification of the nucleic acids and relies on monitoring fluorescence of the reaction solution as a function of temperature. The fluorescent molecules used can be double-stranded DNA binding fluorophores or fluorescently labeled probes.

Typically almost fully saturating dsDNA binding fluorophore is required for a successful HRM analysis. This requirement limits the selection of possible fluorophores as many of them would be required in concentrations too high to allow efficient amplification.

Traditional HRM analysis is not well suited for quantitative analysis. As an example, in some cases it would be beneficial to be able to quantitatively assess the relative abundance of a mutant sequence in a heterogeneous sample. This type of information would be valuable for example in analysis of acquired single nucleotide polymorphisms (SNPs) related to cancer and analysis of aneuploidy.

In addition, the resolution capability of traditional HRM restricts its use e.g. in detecting homozygous SNP mutants as the differences in melting temperatures are minor.

### SUMMARY

Therefore, it is an object of the present invention to provide an analysis technique that is suitable for quantitative analysis of nucleic acid molecules and that enables detection and/or identification of nucleic acids in a sample at a good resolution (in terms of differences in melting temperature).

The objects of the invention are reached by a method, by an apparatus and by a computer program as defined by the respective independent claims.

In this regard, a novel method for analyzing a melt curve characterizing the melt of a solution comprising one or more populations of nucleic acid molecules and a constant number of fluorophores of at least first type is provided.

Said method comprises obtaining a fluorescence signal descriptive of melt curve data over a temperature range, the fluorescence signal representing the intensity of the light emitted by said fluorophores as a function of temperature, modeling the fluorescence signal at a plurality of temperatures within the temperature range as a sum of a first signal component representing the combined light intensity emitted by unbound fluorophores of said first type in the solution at a given temperature and a set of one or more second signal components, each representing the combined light intensity emitted by said fluorophores bound to the respective nucleic acid molecule population at the given temperature, wherein the first signal component is provided as a product of a first term representing the relative number of unbound fluorophores of said first type at the given temperature and a second term representing the emission efficiency of an unbound fluorophore of said first type at said given temperature and wherein each second signal component is provided as a product of a respective third term representing the relative number of said fluorophores bound to the respective nucleic acid molecule population at the given temperature and a respective fourth term representing the emission efficiency of said fluorophore bound to the respective nucleic acid molecule population at said given temperature, and utilizing numerical analysis to determine the values of said first, second, third and fourth terms at said plurality of temperatures such that the difference between the fluorescence signal and the modeled fluorescence signal meets a predefined criterion.

The method may comprise modeling each of said third terms as a product of the overall number of binding locations for the respective nucleic acid molecule population at said given temperature and the value of a first parametric function that is descriptive of the occupancy level of said overall number of binding locations as a function of the relative number of unbound fluorophores in the solution, wherein said overall number of binding locations is determined by a second parametric function that is descriptive of the melting probability of the respective nucleic acid molecule population as a function of temperature, and wherein determining the values for each of said third terms comprises determining parameter values of said first and second parametric functions.

Alternatively or additionally, the method may comprise modeling said second term by a third parametric function that is descriptive of the emission efficiency of an unbound fluorophore of said first type as a function of temperature and modeling each of said fourth terms by a respective fourth parametric function that is descriptive of the emission efficiency of said fluorophore bound to the respective nucleic acid molecule population as a function of temperature, wherein determining the values for said second term comprises determining parameter values of said third parametric function and wherein determining the values for each of said fourth terms comprises determining parameter values for the respective fourth parametric function.

The numerical analysis may comprise setting at least one of said terms to predetermined values at said plurality of temperatures, and employing numerical analysis to determine values of the other terms at said plurality of temperatures. Said setting may comprise setting said second term and each of said fourth terms to respective predetermined values and said employing may comprise employing numerical analysis to determine values of the first term and each of said third terms to enable determination of relative concentrations and/or characteristics of the one or more nucleic acid molecule populations in the solution. Alternatively, said setting may comprise setting said first term and each of said third terms to respective predetermined values and said employing may comprise comprises employing numerical analysis to determine values of the second term and each of said fourth terms to enable determination of characteristics of the fluorophores of said first type.

Said nucleic acid molecules may comprise, for example, DNA target sequences of one or more types originating from a polymerase chain reaction, and/or said fluorophores may comprise a plurality of one or more of the following: LC Green, LC Green+, Eva Green, SYTO9, SYBR Green.

Further in this regard, a novel apparatus for analyzing a melt curve characterizing the melt of a solution comprising one or more populations of nucleic acid molecules and a constant number of fluorophores of at least first type is provided. Said apparatus comprises at least one processor and at least one memory including computer program code for one or more programs, the at least one memory and the computer program code configured to, with the at least one processor, cause the apparatus at least to obtain a fluorescence signal descriptive of melt curve data over a temperature range, the fluorescence signal representing the intensity of the light emitted by fluorophores of said first type as a function of temperature, to model the fluorescence signal at a plurality of temperatures within the temperature range as a sum of a first signal component representing the combined light intensity emitted by unbound fluorophores of said first type in the solution at a given temperature and a set of one or more second signal components, each representing the combined light intensity emitted by said fluorophores bound to the respective nucleic acid molecute population at the given temperature, wherein the first signal component is provided as a product of a first term representing the relative number of unbound fluorophores of said first type at the given temperature and a second term representing the emission efficiency of an unbound fluorophore of said first type at said given temperature and wherein each second signal component is provided as a product of a respective third term representing the relative number of said fluorophores bound to the respective nucleic acid molecule population at the given temperature and a respective fourth term representing the emission efficiency of said fluorophore bound to the respective nucleic acid molecule population at said given temperature, and to utilize numerical analysis to determine the values of said first, second, third and fourth terms at said plurality of temperatures such that the difference between the first fluorescence signal and the modeled fluorescence signal meets a predefined criterion.

Further in this regard, a novel computer program for analyzing a melt curve characterizing the melt of a solution comprising one or more populations of nucleic acid molecules and a constant number of fluorophores of at least first type is provided. The computer program comprises one or more sequences of one or more instructions which, when executed by one or more processors, cause an apparatus at least to obtain a fluorescence signal descriptive of melt curve data over a temperature range, the fluorescence signal representing the intensity of the light emitted by fluorophores of said first type as a function of temperature, to model the fluorescence signal at a plurality of temperatures within the temperature range as a sum of a first signal component representing the combined light intensity emitted by unbound fluorophores of said first type in the solution at a given temperature and a set of one or more second signal components, each representing the combined light intensity emitted by said fluorophores bound to the respective nucleic acid molecule population at the given temperature, wherein the first signal component is provided as a product of a first term representing the relative number of unbound fluorophores of said first type at the given temperature and a second term representing the emission efficiency of an unbound fluorophore of said first type at said given temperature and wherein each second signal component is provided as a product of a respective third term representing the relative number of said fluorophores bound to the respective nucleic acid molecule population at the given temperature and a respective fourth term representing the emission efficiency of said fluorophore bound to the respective nucleic acid molecule population at said given temperature, and to utilize numerical analysis to determine the values of said first, second, third and fourth terms at said plurality of temperatures such that the difference between the first fluorescence signal and the modeled fluorescence signal meets a predefined criterion.

The computer program may be embodied on a volatile or a non-volatile computer-readable record medium, for example as a computer program product comprising at least one computer readable non-transitory medium having program code stored thereon, the program code, which when executed by an apparatus, causes the apparatus at least to perform the operations described hereinbefore for the computer program.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

The novel features which are considered as characteristic of the invention are set forth in particular in the appended claims. The invention itself, however, both as to its construction and its method of operation, together with additional objects and advantages thereof, will be best understood from the following detailed description of specific embodiments when read in connection with the accompanying drawings.

### BRIEF DESCRIPTION OF THE DRAWINGS

FIG. 1 illustrates an exemplifying melt curve.

FIG. 2 illustrates examples of emission efficiency of fluorophores as a function of time.

FIG. 3 schematically illustrates an example of bounding of fluorophores.

FIG. 4 illustrates an exemplifying melt curve.

FIG. 5a schematically illustrates an example of a change in binding status of fluorophores.

FIG. 5b schematically illustrates an example of binding status fluorophores.

FIG. 5c schematically illustrates an example of a change in binding status of fluorophores.

FIG. 5d schematically illustrates an example of binding status fluorophores.

FIG. 6 illustrates an example of the melt probability as a function of temperature and an example of the overall number of binding locations as a function of temperature.

FIG. 7 illustrates an example of the melt probability as a function of temperature and an example of the overall number of binding locations as a function of temperature.

FIG. 8 illustrates examples of the occupancy level of the binding locations as a function of the number of unbound fluorophores.

FIG. 9 illustrates an exemplifying method in accordance with an embodiment.

FIG. 10 illustrates an example of relative overall number of binding locations as a function of temperature.

FIG. 11 illustrates an example of fluorescence signal components descriptive of relative intensities of light intensities of two nucleic acid molecule populations as a function of temperature.

FIG. 12 schematically illustrates an exemplifying apparatus in accordance with an embodiment.

### DETAILED DESCRIPTION OF SOME EMBODIMENTS

Herein, the term fluorophore or fluorophore molecule or dye is used to refer to a reporter molecule that is able to absorb light energy at a first range of wavelengths and, in response, emit light energy at a second range of wavelengths.

Herein, the term nucleic acid molecule is used to refer to a DNA molecule, to a RNA molecule or to a combination and/or derivative thereof. Moreover, also the term target is used, alternatively, to refer to a DNA molecule, to a RNA molecule or to a combination and/or derivative thereof.

Herein, the term population is used to refer to a group of similar molecules. As an example, the term population may be used to refer to a group of similar nucleic acid molecules or to a group of similar fluorophores. Furthermore, the term population or the term sub-population may be used to refer to a subgroup, e.g. to first and second subgroups of a population of fluorophores. Bound and unbound fluorophores are examples of subpopulations.

Herein, the term melt curve is used to refer to a signal or a set of values describing the melting behavior of a solution as a function of temperature over a temperature range of interest. An example of signal applicable as a melt curve is a fluorescence signal descriptive of the intensity of light emitted by the solution of interest as a function of temperature. Another example of a melt curve signal is a fluorescence signal descriptive of the intensity of light emitted by a solution comprising a nucleic acid and a fluorophore as a function of temperature. The values are typically expressed graphically.

Herein, the term emission efficiency is used to refer to the amplitude or to the relative amplitude of a signal, e.g. relative light intensity of a fluorescence signal serving as a melt curve.

Single stranded nucleic acid molecules, DNA and RNA, have an ability to specifically pair with a second strand using intrinsic pairing capabilities of the nucleotide bases to form a double stranded structure. Double stranded nucleic acid molecules have a characteristic denaturation (i.e. dissociation of the strands from each other) temperature which is dependent on the base sequences of the strands. The melting temperature (Tₘ) is the temperature at which one-half of a particular DNA duplex will dissociate and become single stranded DNA. The stability of a primer-template DNA duplex can also be measured by its Tₘ.

The nucleic acid molecule according to this invention is DNA or RNA or any combination thereof, preferably the nucleic acid is a stranded nucleic acid molecule. Single stranded nucleic acids can be analyzed after amplification reaction or hybridization with a second nucleic acid resulting in a double stranded structure. The nucleic acid molecule can be of any type, such as genomic DNA, mRNA or siRNA. Nucleic acid can be naturally existing, modified or artificial nucleic acid that can be amplified by e.g. Polymerase Chain Reaction (PCR). The nucleic acid molecule can contain, or consists of, modified nucleic acids of any type. Examples of modified nucleic acids are morpholino- and locked nucleic acids (LNAs), Peptide nucleic acids (PNAs), glycol nucleic acids, threose nucleic acids and Minor groove binders.

The double stranded nucleic acid molecule(s) (to be analyzed) can be a nonamplified double stranded molecule. This is possible if the nucleic acid content of the sample is sufficiently high to allow detection. Typically the nucleic acid molecules are amplified before melt curve analysis using PCR, preferably qPCR. PCR has been used since 1980's to amplify nucleic acid molecules such as DNA and RNA across several orders of magnitude (see e.g. U.S. Pat. No. 4,683,202). Quantitative real-time PCR (qPCR) is a method in which fluorescent dyes are used to detect the amount of PCR product after each PCR cycle (see e.g. U.S. Pat. No. 5,994,056). Real-time qPCR is a very effective tool for gene expression analysis. It is the most sensitive method for the detection and quantitation of low abundance mRNA in samples. Known applications of qPCR include e.g. verifying microarray results, single-cell qRT-PCR, diagnostics including genotyping and detection of viruses, bacteria and parasites. RNA molecules are amplified using reverse transcription PCR (rtPCR). Quantitative reverse transcription PCR (qRT-PCR) is used when the starting material for the assay is RNA.

Melt curve analysis (melting curve analysis) is an assessment of the dissociation-characteristics of a double-stranded nucleic acid molecule during heating (U.S. Pat. No. 5,871,908, U.S. Pat. No. 6,174,670). As the temperature is raised, the double strand begins to dissociate leading to a rise in the absorbance intensity. The melting temperature (Tm) is often calculated by the instrument software from the melting curve data by plotting the negative first derivative versus temperature (dF/dT). The derivative melting peak is highest at the melting temperature. The Tm of a DNA fragment is dependent on its length, G+C composition, sequence, strand complementarity, concentration, and on buffer components such as salts, dye, and PCR enhancers

High resolution melt (HRM) analysis enables the analysis of nucleic acid samples based on small differences in their sequence, length, G+C content, and strand complementarity. It has been used for several powerful applications, including mutation discovery (gene scanning), screening for loss of heterozygosity, DNA fingerprinting, SNP genotyping, characterization of haplotype blocks, DNA methylation analysis, DNA mapping, species identification, somatic acquired mutation ratios, HLA compatibility typing, association (case/control) studies, allelic prevalence in a population and identification of candidate predisposition genes.

Fluorophores absorb light energy at one wavelength and, in response, re-emit light energy at another, longer wavelength. Each fluorophore has a distinctive range of wavelengths at which it absorbs light and another distinct range of wavelengths at which it emits light. This property enables their use for specific detection of PCR products by real-time PCR instruments and by other analysis tools and/or analysis techniques.

The term quenching describes a decrease in the quantum yield of a given fluorescence process, which results in a decrease in the intensity of the emitted light. Quenchers are molecules that can accept energy from fluorophores and then dissipate it without emitting light at the same range as the donor fluorophore (light emission). This transfer of energy between two molecules is termed FRET (Fluorescence Resonance Energy Transfer). When a quencher is removed from a close proximity to its corresponding fluorophore molecule, the fluorophore molecule can again release its extra energy as fluorescence at its characteristic wavelength. Some examples of FRET fluorophore pairs are FAM-TAMRA and VIC-TAMRA.

There are two basic functional types of fluorophores. Fluorophores of a first type have the capability to incorporate into double stranded nucleic acid molecules. SYBR Green I is an example of a well-known fluorophore of this type. It is the most commonly used fluorophore for qPRC applications. Other suitable fluorophores of this type include ethidium bromide, BEBO, BOXTO, LC Green, SYTO9 and EvaGreen.

Fluorophores of a second type may be used as tags or labels attached to short nucleic acid strands, typically primers or probes. Examples of fluorophores of this type include FAM, HEX, NED and TAMRA. Some of the fluorophores of this type can be used as quencher molecules. Known quencher molecules include other fluorophores acquiring the energy from the primary fluorophore and emitting at a different wavelength, and quenchers that do not emit visible light such as Black Hole Quencher (BHQ) product family.

The detection chemistries used for qPCR and melt curve analysis can be divided into two basic groups: nonspecific chemistries that usually detect fluorescence of a target-binding dye, e.g. a DNA-binding dye, and target specific chemistries that usually utilize fluorescent probes and/or primers. In the following, DNA is used as an example of a target (or a nucleic acid molecule), but the discussion equally well applies to targets (or nucleic acid molecules) of other type.

Several types of specific detection chemistries are available commercially. They utilize tagged oligonucleotide probes that are specifically designed to detect the target DNA sequence. Fluorescent tags or labels are preferred. Hydrolysis probes are the most commonly used qPCR probes (e.g. TaqMan probes) but they are not applicable to be used in melt curve analysis. Other target-specific detection chemistries, also applicable in melt curve analysis, include hairpin probes (of which Molecular Beacon probes are the most popular), LightUp probes and hybridization probes (also called FRET probes) including MGB containing hybridization probes (Solaris, Pleiades).

The most straightforward and least costly approach to melt curve analysis uses DNA-binding fluorophores or other reporter molecules for nonspecific detection of target DNA sequences. This is both rapid and economical to perform as standard primers and nonspecific dyes can be used. With nonspecific detection chemistries the sensitivity and specificity of the assay is determined only by the PCR primers.

Typically the PCR instrument is set to perform a melting curve analysis after the completion of PCR amplification by gradually increasing the temperature and monitoring the fluorescence as a function of the temperature. As another example, the melt curve analysis may be carried out by an instrument or apparatus separate from the PCR instrument after completion of the PCR amplification. A sharp drop in the fluorescence occurs when the temperature is high enough to denature dsDNA, and the fluorophore molecule is released.

Basic melt curve analysis is usually used to check specificity of the PCR reaction. Data is typically collected e.g. in 0.5° C. temperature increments. Due to lower resolution requirements basic melt curve analysis can be performed in nonsaturating fluorophore conditions using e.g. SYBR Green.

In HRM experiments the data is commonly collected in 0.2° C. and smaller temperature increments. Dye-based HRM analysis utilizes DNA binding fluorophores that can be used in saturating conditions without inhibiting the DNA polymerase, such as LC Green and Eva Green. The saturating concentration prevents dye molecule redistribution during melting and provides better resolution. Probe-based melting is different only in that typically the PCR amplification step is asymmetric, meaning that one of the strands is designed to amplify more efficiently than the other strand.

It is also possible to add a nonspecific dye (for example BOXTO, BEBO) to a probe-based qPCR reaction, as described e.g. in the article “Combining sequence-specific probes and DNA binding dyes in real-time PCR for specific nucleic acid quantification and melting curve analysis”, Kristina Lind, Anders Ståhlberg, Neven Zoric, and Mikael Kubista, BioTechniques 40:315-319, March 2006. The advantage gained is the ability the check the specificity of the qPCR reaction with a melt analysis without having to add the dye separately after the qPCR phase. This reduces the risk for contaminations.

Embodiments of the invention enable taking into account the relocalization of the fluorophore dissociated from a first melted region, thus e.g. enabling HRM analysis in nonsaturating conditions.

While the term population is used herein mostly to refer to a group of similar nucleic acid molecules or nucleic acid sequences, e.g. to a group of amplified DNA or RNA sequences, this term may also be used to refer to a group of similar molecules of other kind. As another example of usage of the term, a group of fluorophore molecules of similar type may be referred to as a (single) population of fluorophores, e.g. all fluorophores of the similar type. As a further example, fluorophores may be assigned to separate populations in accordance with its binding status, e.g. fluorophores bound to a first population of nucleic acid molecules may constitute a first population (or a first sub-population) of fluorophores, fluorophores bound to a second population of nucleic acid molecules may be considered to constitute a second population (or a second subpopulation) of fluorophores, while unbound fluorophores may be considered as third population (or a third sub-population) of fluorophores. (In this regard, please refer to more detailed description of fluorophores and their binding status hereinafter.)

FIG. 1 illustrates an exemplifying melt curve 110. A melt curve, such as the melt curve 110, is descriptive of melting behavior of one or more nucleic acid molecule populations in a solution under study over a range of temperatures of interest, where the term population refers to a group of similar nucleic acid molecules. In other words, the melt curve 110 describes the melting behavior of the solution as a whole. Such nucleic acid molecules may be, for example, DNA target sequences resulting from a PCR process, as described hereinbefore. Further examples of nucleic acid molecules include fragments amplified by other methods including isothermal amplification, extracted fragments for example resulting from restriction endonuclease digestion and precipitated fragments resulting from for example immunoprecipitation.

Each of the one or more nucleic acid molecule populations included in the solution under study exhibit melting behavior that is characteristics of its type and sequence. In case of a solution comprising nucleic acid molecule populations of two or more different sequences the melt curve is indicative of the joint melting behavior of the two or more nucleic acid molecule populations and it is typically not possible to extract a melt curve specific to any of the individual nucleic acid molecule populations without resorting to complex analysis techniques. In case of a solution comprising a single population of nucleic acid molecules, the melt curve 110 may directly indicate the melting behavior of the single nucleic acid molecule population. However, depending on the characteristics of the fluorophores or reporter molecules of other type applied as basis of derivation of the melt curve 110, the relationship between the melt curve 110 descriptive of the melting behavior of the solution as a whole and a melt curve specific to the single nucleic acid molecule population included in the solution may be somewhat more complex. Consequently, further analysis may be required in order to enable extracting the melting behavior of the single nucleic acid molecule population on basis of the overall melt curve 110.

Hereinafter, for brevity and clarity of description, a fluorophore molecule is referred to simply as a fluorophore. A fluorophore in the solution of interest may be a free fluorophore that is not bound to any of the nucleic acid molecules of the solution, i.e. an unbound fluorophore. Alternatively, a fluorophore may be bound to one of the nucleic acid molecules of the solution. Light emitted by a fluorophore typically depends on its binding to one of the nucleic acid molecules in the solution, i.e. on the binding status of the fluorophore. As an example, unbound double stranded DNA binding fluorophores emit light at a first light intensity, while they emit light at a second light intensity when they are bound to a population of double stranded nucleic acid molecules, wherein the first light intensity is significantly lower than the second light intensity. The second light intensity, is dependent on the amount of double stranded areas in the nucleic acid molecules, thereby providing light intensity that is dependent on the sequence of the nucleic acid molecules to which the respective fluorophores are bound, detectable during the melting or reannealing process. The first and second light intensities used as an example herein and/or the wavelength of the light emitted by the fluorophores depend on the characteristics of the employed fluorophores. The first and the second light intensities may further depend on environmental factors, such as chemical composition of the surrounding solution.

The example of a melt curve 110 is a fluorescence signal descriptive of the intensity of light emitted by the solution of interest as a function of temperature. Fluorescence signal suitable for representing melt curve data and hence the melt curve 110 may be created by providing the solution under study with a known number, known concentration and/or known volume of fluorophore molecules of a certain type and increasing the temperature of the solution from a starting temperature up to a final temperature while at the same time exciting the solution—especially the fluorophores therein—with a light at a first wavelength that is characteristics of the type of the employed fluorophore molecules. As a consequence, the fluorophore molecules emit light at a second wavelength that is characteristics of the employed fluorophore molecules. The light hence emitted by the solution constitutes the fluorescence signal that is hence descriptive of the melt curve data.

While the intensity of light emitted by a fluorophore population may be constant or essentially constant regardless of the temperature, typically the intensity of light emitted by a fluorophore population further depends on temperature (and thus dissociation status of nucleic acids), e.g. such that effective emission efficiency of the fluorophore population decreases with increasing temperature. Increasing temperature means that the molecules of the solution exhibit more movement and thus the probability of collisions between the molecules increases. A fluorophore brought into an excited state normally results in the fluorophore emitting light at a wavelength characteristics thereof, but a collision may provide an alternative relaxation path from the excited state through phonon interactions, thereby resulting in the fluorophore failing to emit light despite the excited state. Therefore, for some fluorophore populations increasing temperature implies lower emission efficiency.

As an example in this regard, the emission efficiency η_{i,tot} may exhibit exponential decay with increasing temperature, e.g. according to a parametric function in accordance with equation (1).

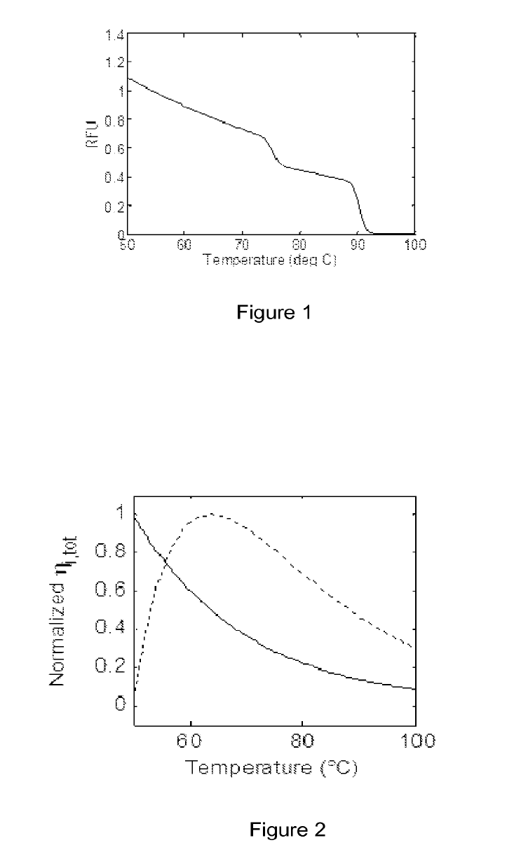

η_{i,tot}(T)=ηᵢe^{-T/τ}^{ᵢ}, (1)

wherein the parameters ηᵢ represent a reference emission efficiency of a given fluorophore population, T represents the temperature and the parameters τᵢ represent an emission efficiency decay coefficient for the given fluorophore population due to intermolecular collisions. As a non-limiting example, the values of the parameters τᵢ may be in the range from 5 to 500 1/° C. A parameter with subscript i=0 indicates a respective parameter of the equation (1) for a population of unbound fluorophores, whereas a parameter with subscript i>0 indicates a respective parameter of the equation (1) for a fluorophore population bound to one of the nucleic acid molecule populations in the solution of interest. The values of the reference emission efficiencies nᵢ serve to indicate the relative emission efficiency of a population of unbound fluorophores in comparison to other fluorophores in the solution, i.e. in comparison to the fluorophore populations bound to molecules of one of the nucleic acid molecule populations and hence their absolute values are typically not of essential importance regarding applicability of the emission efficiency model according to the equation (1). However, it is possible to use a priori known reference values for a given type of fluorophore and/or for given nucleic acid molecule populations in case such information is available. Instead of modeling the emission efficiency as a monotonic exponential decay with increasing temperature, the decay may be, alternatively, modeled e.g. by a linear function or a piecewise linear function exhibiting monotonic decrease with increasing temperature. An example of a function of temperature descriptive of the emission efficiency η_{i,tot} at a given temperature in accordance with the equation (1) is provided by the solid curve in FIG. 2.

Although a monotonic decay in emission efficiency η_{i,tot} with increasing temperature may be considered as characteristics of fluorophores of several types, characteristics of some types of fluorophores may change over temperature and hence the emission efficiency thereof may exhibit more complex dependence on temperature. Alternatively, the solution may contain quencher molecules with temperature dependent behavior. E.g. fluorophores that are quenched at low temperatures may exhibit emission efficiency η_{i,tot} as a function of temperature in accordance with a parametric function according to equation (2).

η_{i,tot}(T)=ηᵢe^{-T/τ}^{₁ᵢ}(1−e^{-T/τ}^{₂ᵢ}), (2)

wherein the parameters τ₁ᵢ represent the emission efficiency decay coefficient for a given fluorophore population due to intermolecular collisions and the parameters τ₂ᵢ represent the emission efficiency decay coefficient due to quenching, while the rest of the parameters of the equation (2) represent the same physical characteristics as described for the equation (1). An example of a function of temperature descriptive of the emission efficiency η_{i,tot} at a given temperature in accordance with the equation (2) is provided by the dashed curve in FIG. 2.

The solution under study typically comprises a high number of instances of each of the one or more nucleic acid molecule sequences, in other words the solution may be considered to comprise one or more nucleic acid molecule populations, each population comprising a high number of respective nucleic acid molecules having characteristic sequences. Each of the one or more double stranded nucleic acid molecule populations contain an overall number of binding locations Nᵢ to which a fluorophore may bind, where the subscript i indicates the respective nucleic acid molecule population. Typically, only a portion of the overall number of binding locations Nᵢ for a given nucleic acid population is occupied. The number of occupied binding locations is denoted as nᵢ and hence the occupancy level is indicated by nᵢ/Nᵢ.

When a given nucleic acid molecule population is melting, its overall number of binding locations Nᵢ decreases with increasing temperature and at the same time the given nucleic acid molecule population releases fluorophores from its binding locations. Consequently, also the occupancy level nᵢ/Nᵢ, of the binding locations of the given nucleic acid molecule population changes. This phenomenon is discussed in more detail hereinafter. The fluorophores released from the given nucleic acid molecule population become unbound fluorophores, fluorophores bound to another nucleic acid molecule population of the solution or fluorophores bound to another binding locations of the same nucleic acid population of the solution. Hence, a fluorophore released from the given nucleic acid molecule changes location from the given nucleic acid molecule binding location to somewhere else but does not disappear from the solution and, consequently, the overall number of the fluorophores nₜₒₜ in the solution remains constant despite the melting of the given nucleic acid molecule population. Hence, the overall number of fluorophores nₜₒₜ in the solution can be expressed e.g. by equation (3):

nₜₒₜ=n₀(T)+Σᵢ₌₁^{N}^{_{tgt}}nᵢ(T), (3)

wherein the parameter n₀(T) represents the number of unbound fluorophores in the solution at temperature T, the parameters nᵢ(T) represent the number of fluorophores bound to the nucleic acid molecule population i at temperature T and the parameter N_{tgt} indicates the overall number of nucleic acid molecule populations in the solution. Thus, the parameter n₀(T) may be considered as an indication of the relative size of the population of unbound fluorophores, while the parameters nᵢ(T) may be considered as indications of the relative sizes of the populations of fluorophores bound to the molecules of the nucleic acid molecule population i.

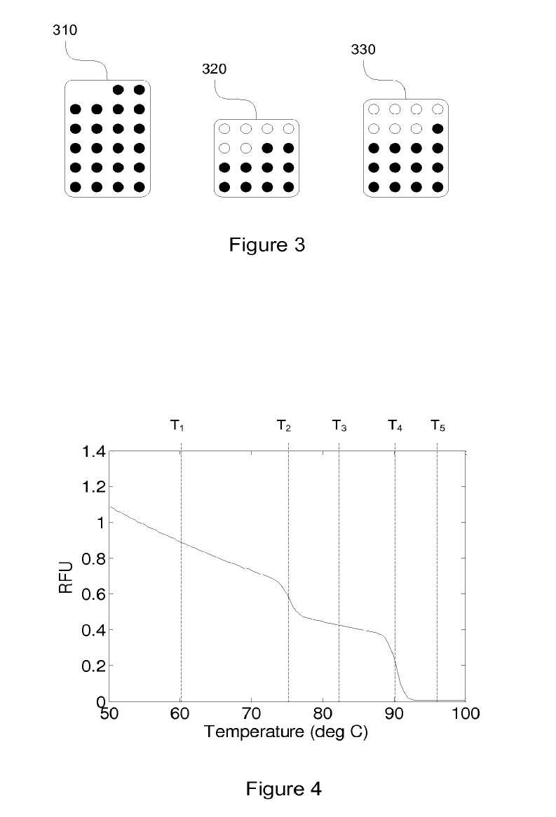

FIG. 3 schematically illustrates this model by indicating the population of unbound fluorophores 310, the population of fluorophores bound to nucleic acid molecules of a first population 320 and the population of fluorophores bound to nucleic acid molecules of a second population 330 at a given temperature T. In the illustration the black circles indicate fluorophores bound to the respective nucleic acid molecule population while white circles indicate unoccupied binding locations in the nucleic acid molecules of the first and second population 320, 330. Hence, according to the example of FIG. 3 at the given temperature T there are 22 unbound fluorophores, 10 fluorophores bound to the 16 binding locations of the nucleic acid molecules of the first population 320 thereby providing the occupancy level 10/16=0.625 and 13 fluorophores bound to the 20 binding locations of the nucleic acid molecules of the second population 330 hence providing the occupancy level 13/20=0.65.

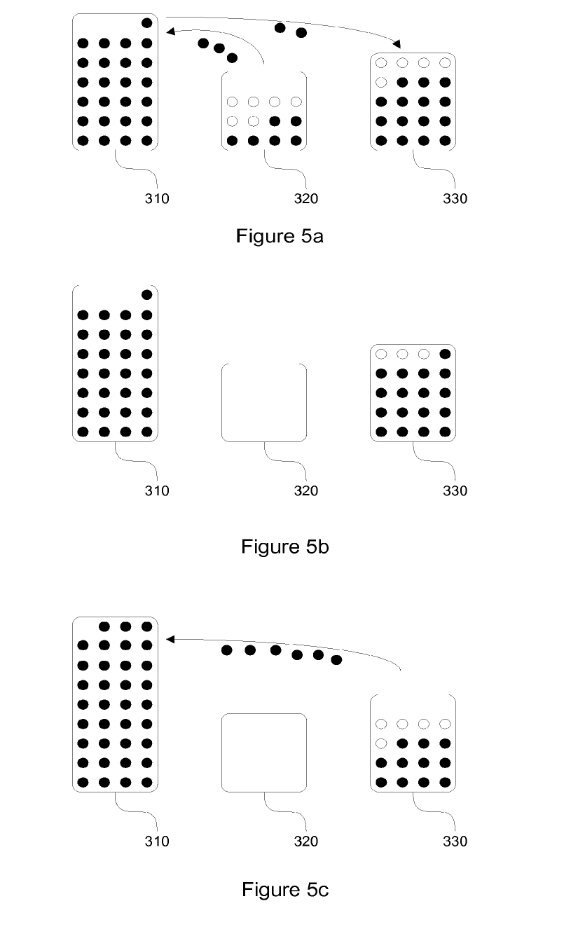

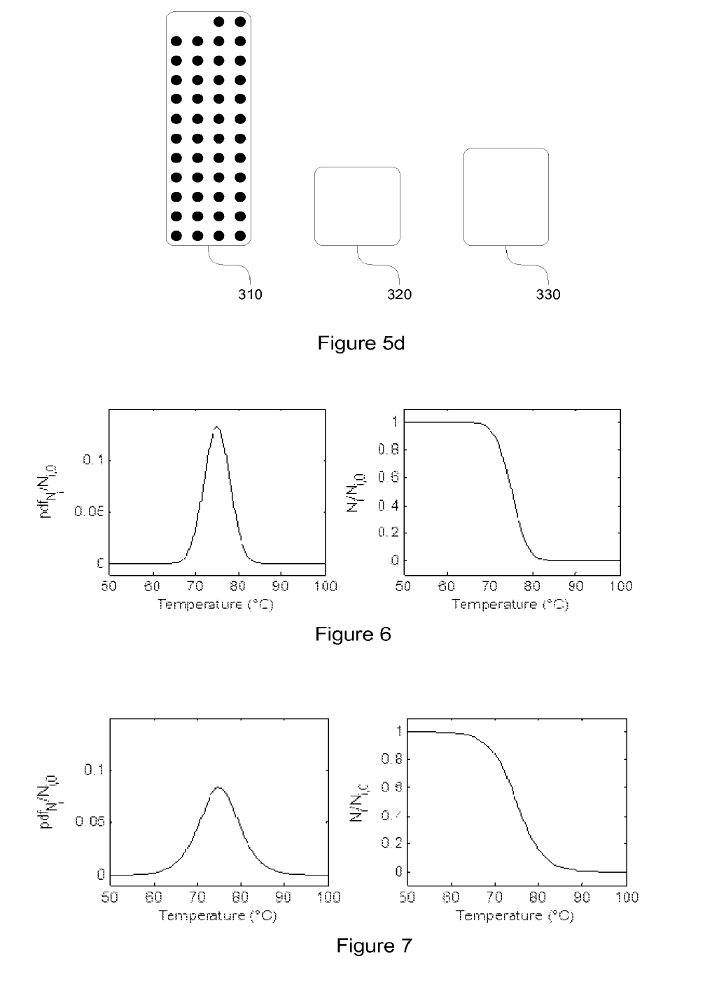

FIG. 4 illustrates an exemplifying melt curve for a solution comprising the nucleic acid molecules of the first population 320 and the second population 330, the melt curve extending from 50° C. to 100° C. At temperature T₁=60° C., and generally before any melting of the nucleic acid molecules of the first population 320 takes place, the overall number of binding locations and the number of fluorophores bound thereto are those indicated in the example of FIG. 3, i.e. N₁=16, n₁=10, N₂=20 and n₂=13. At and/or around temperature T₂, which is the average melting temperature of the nucleic acid molecules of the first population 320, the nucleic acid molecules of the first population 320 start to loose binding locations due to melting, i.e. N₁(T₁)>N₁(T₂). Consequently, some of the fluorophores bound to the nucleic acid molecules of the first population 320 become unbound fluorophores 310 and some of them further get bound to the nucleic acid molecules of the second population 330. This change of fluorophore binding status at and/or around temperature T₂ is schematically illustrated in FIG. 5a.

At temperature T₃ the nucleic acid molecules of the first population 320 have completely melted and, consequently, have lost all the binding locations, i.e. N₁(T₃)=0, whereas the nucleic acid molecules of the second population 330 having the average melting temperature at T₄ still continue to have the original overall number of binding locations, i.e. N₂=20 and the number of fluorophores bound thereto is in this example is n₂=17. The binding status of the fluorophores at and/or around temperature T₃ is schematically illustrated in FIG. 5b.

Furthermore, at and/or around temperature T₄, which is the average melting temperature of the nucleic acid molecules of the second population 330, the nucleic acid molecules of the second population 330 start to loose binding locations due to melting, i.e. N₂(T₃)>N₂(T₄). Consequently, some of the fluorophores bound to the nucleic acid molecules of the second population 330 become unbound fluorophores 310. This change of fluorophore binding status at and/or around temperature T₄ is schematically illustrated in FIG. 5c. Finally, at temperature T₅ also the nucleic acid molecules of the second population 330 have completely melted and hence lost all their binding locations, i.e. N₂(T₅)=0. Consequently, all fluorophores of the solution have become unbound fluorophores 310. The binding status of the fluorophores at and/or around temperature T₅ is schematically illustrated in FIG. 5d.

The melting process of a given nucleic acid molecule population may be modeled by a probability density function descriptive of the melting behavior as a function of time, especially at and/or around the melting temperature T_{m,i}. As an example, the probability of the melting of the nucleic acid molecule population i may be assumed to follow normal distribution and hence the melting probability may be expressed as a function of temperature as a Gaussian probability density function

$${pdf}_{Ni} ( T ; {T}_{m , i} , {σ}_{i}^{2} ) = \frac{{dN}_{i } ( T )}{dT} = \frac{{N}_{i , 0}}{{σ}_{i} \sqrt{2 π}} {e}^{- \frac{1}{2} {( \frac{T - {T}_{m , i}}{{σ}_{i}} )}^{2}} , \qquad ( 4 )$$

wherein T represents the temperature, the parameters N_{i,0} represent the overall number of binding locations of the nucleic acid molecules of population i before essentially any melting has taken place, the parameters T_{m,i} represent the melting temperature of the nucleic acid molecules of population i and the parameters σᵢ represent the melt width of the nucleic acid molecule population i. The melting temperature T_{m,i} and the melt width σᵢ are parameters characterizing a nucleic acid molecule population and hence these parameters may be e.g. employed to identify a nucleic acid molecule population.

Consequently, the overall number of binding locations for the nucleic acid molecule population i may be obtained through the cumulative probability distribution

$$\begin{matrix}{N}_{i} ( T ) = {N}_{i , 0} [ 1 - {\int }_{0}^{T} {pdf}_{Ni} ( ξ ; {T}_{m , i} , {σ}_{i}^{2} ) d ξ ] \\ = {N}_{i , 0} [ \frac{1}{2} - \frac{1}{2} erf ( \frac{T - {T}_{m , i}}{\sqrt{2 {σ}_{i}^{2}}} ) ] ,\end{matrix} \qquad ( 5 )$$

where erf( ) is the error function, as known in the art, exhibiting sigmoid shape. The error function erf( ) is defined as

$$erf ( x ) = \frac{2}{\sqrt{π}} {\int }_{0}^{x} {e}^{- {t}^{2}} dt .$$

The melt probability as a function of temperature according to the equation (4) is illustrated by an example with T_{m,i}=75° C. and σᵢ=3° C. by the curve of FIG. 6 in the left, while the curve in the right in FIG. 6 depicts the corresponding number overall binding locations as a function of temperature according to the equation (5).

Another example of a probability density function suitable for modeling the melting of the nucleic acid molecule population i is a logistic probability distribution according to

$${pdf}_{Ni} ( T ; {T}_{m , i} , σ ) = \frac{{dN}_{i }}{dT} = \frac{{N}_{i , 0}}{4 π} {sech}^{2} ( \frac{T - {T}_{m , i}}{2 σ} ) . \qquad ( 6 )$$

Consequently, the overall number of binding locations for the nucleic acid molecule population i may be obtained through the cumulative probability distribution

$$\begin{matrix}{N}_{i} ( T ) = {N}_{i , 0} [ 1 - {\int }_{0}^{T} {pdf}_{Ni} ( ξ ; {T}_{m , i} , {σ}_{i}^{2} ) d ξ ] \\ = {N}_{i , 0} [ \frac{1}{2} - \frac{1}{2} tanh ( \frac{T - {T}_{m , i}}{2 σ} ) ] \\ = \frac{{N}_{i , 0}}{1 + exp [ ( T - {T}_{m , i} ) / σ ]}\end{matrix} \qquad ( 7 )$$

The hyperbolic tangent function tan h(x) appearing in the equation (7) is another example of a function exhibiting sigmoid shape.

The melt probability as a function of temperature according to the equation (6) is illustrated by an example with T_{m,i}=75° C. and σᵢ=3° C. by the curve of FIG. 7 in the left, while the curve in the right in FIG. 7 depicts the corresponding number overall binding locations as a function of temperature according to the equation (7).

The normal distribution and the logistic distribution described herein serve as non-limiting examples of suitable probability density functions that can be applied to model the melting probability on basis of a parametric function. Moreover, the respective cumulative probability distributions serve as non-limiting examples of suitable sigmoid functions for modeling the respective overall numbers of binding locations as a function of temperature. In this regard, the probability density functions may apply sigmoid function different from ones employed in the equations (5) and (7), e.g. a cumulative Student's t distribution, arctangent, hyperbolic tangent as well as a number of algebraic functions. Hence, another distribution of a known type or even arbitrary distribution together with a suitable respective cumulative distribution function may be applied. The type of the distribution may be known a priori, or the type of the distribution may be determined or approximated on basis of measured data, e.g. on basis of the melt curve or derivative thereof.

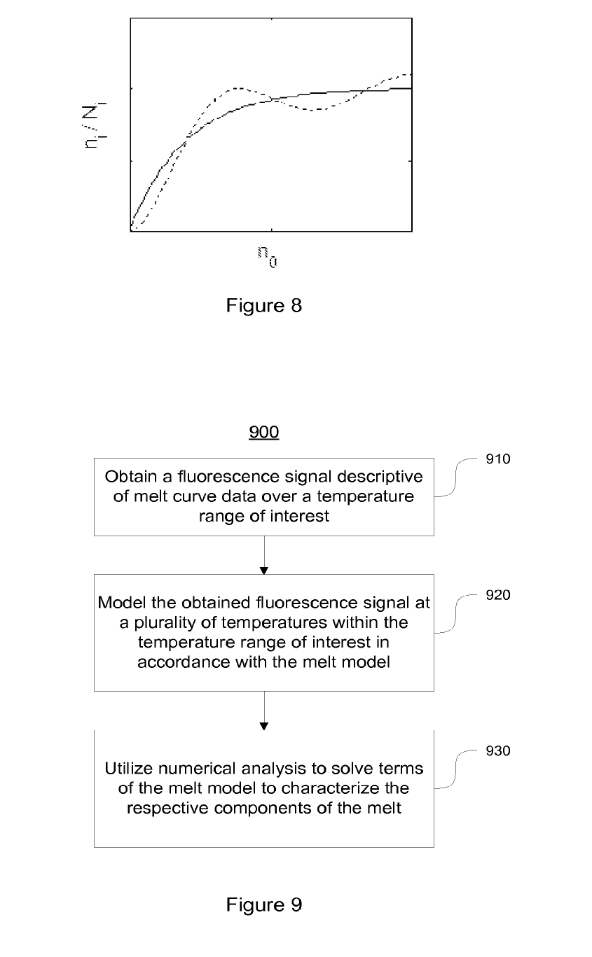

As already briefly pointed out hereinbefore, only a portion of the overall number of binding locations Nᵢ for the nucleic acid molecules of population i is occupied. The occupancy level, typically, depends on the number of unbound fluorophores in the solution. Since, as described hereinbefore, the nucleic acid molecules in the solution release fluorophores when the temperature reaches or exceeds their melting temperature and the strands separate from each other, the number of unbound fluorophores in the solution depends on temperature and, consequently, also the occupancy level nᵢ(T)/Nᵢ(T) depends on temperature at least indirectly. As an example, the occupancy level nᵢ(T)/Nᵢ(T) of the nucleic acid molecules of population i may be modeled with a parametric function that is an exponential function of the number of unbound fluorophores as

$$\frac{{n}_{i} ( T )}{{N}_{i} ( T )} = 1 - {e}^{- {n}_{0} ( T ) / {γ}_{i}} , \qquad ( 8 )$$

wherein the parameter n₀(T) indicates the number of unbound fluorophores in the solution at temperature T and the parameters γᵢ represent the fill balance coefficient for the nucleic acid molecules of population i. The fill balance coefficient depends on the employed fluorophores and may hence be independent of the nucleic acid molecule population, i.e. the parameter γ₁ in the equation (8) may be replaced by a parameter γ that applies to all nucleic acid molecule populations. The solid curve in FIG. 8 illustrates an example of the occupancy level nᵢ(T)/Nᵢ(T) as a function of the number of unbound fluorophores according the equation (8). The number of occupied binding locations nᵢ(T) of the nucleic acid molecules of population i and hence the number of fluorophores bound thereto may be solved on basis of the equation (8) as

nᵢ(T)=Nᵢ(T)(1−e⁻ⁿ^{₀}^{(T)/γi}). (9)

Since the overall number of fluorophores nₜₒₜ in the solution remains constant, substituting the equation (9) into the equation (3) enables expressing the number of fluorophores bound to the each of the nucleic acid molecule populations of the solution via the respective overall number of binding locations and hence rewriting the equation (3) into

n₀(T)=nₜₒₜ−Σᵢ₌₁^{N}^{_{tgt}}Nᵢ(T)(1−e⁻ⁿ^{₀}(T)/γi) (10)

As another example, the occupancy level nᵢ(T)/Nᵢ(T) of the nucleic acid molecules of population i may be modeled with a parametric function that is an exponential function of the number of unbound fluorophores further involving harmonic oscillations as

$$\frac{{n}_{i} ( T )}{{N}_{i} ( T )} = \frac{4}{π} ( 1 - {e}^{- {n}_{0} ( T ) / {γ}_{i}} ) ( sin x + \frac{sin 3 x}{3} + \frac{sin 5 x}{5} ) , \\ 0 < {n}_{0} ( T ) < {n}_{max} , \qquad ( 11 )$$

where

$$x = \frac{π {n}_{0} ( T )}{{n}_{max} {γ}_{i}} .$$

while the other parameters of the equation (11) are described in context of the equation (8). The dashed curve in FIG. 8 illustrates an example of the occupancy level nᵢ(T)/Nᵢ(T) as a function of the number of unbound fluorophores according to the equation (11). Consequently, the equation (11) may be used to express the number of fluorophores bound to the each of the nucleic acid molecule populations of the solution via the respective overall number of binding locations e.g. in the equation (3) along the lines shown above for the equation (9).

While the equations (8) and (11) provided non-limiting examples of parametric functions suitable for modeling the occupancy level nᵢ(T)/Nᵢ(T) as a function of the number of unbound fluorophores, a function different from these, even an arbitrary function, may be applied.

The description hereinbefore has assumed that the solution under study is provided with fluorophores of a single type, hence having similar behavior in dependence of their binding status and as a function of temperature. However, it is possible to employ fluorophores of two or more different types in order to obtain respective two or more fluorescence signals descriptive of melt curve data. While a single binding location according to the model described e.g. in context of FIGS. 3 and 5a to 5d is assumed to be able to bind only a single fluorophore of a given type at a time, it can be assumed that a single binding location is able to simultaneously bind two or more fluorophores of different types.

The fluorophores of different type, preferably, emit light at different wavelengths to facilitate distinguishing between the light originating from the fluorophores of different types. Furthermore, the fluorophores of different type may exhibit different change in the emission efficiency as a function of temperature and/or different evolution of the occupancy level of DNA target binding locations as a function of the number of unbound fluorophores in the solution under study. While the former aspect of the fluorophore behavior may be modeled e.g. based on the equation (1) or (2), the parameters of the emission efficiency model are different for each of the two or more types of fluorophores. Similarly, while the latter aspect of the nucleic acid molecule behavior may be modeled e.g. based on the equations (8) or (11), the parameters of the occupancy level model are different for each of the two or more types of fluorophores. Consequently, employing fluorophores of two or more different types serves to provide two or more fluorescence signals descriptive of the melt curve data that are at least in part mutually independent, hence improving the accuracy and reliability of the analysis

The exemplifying equations suitable for modeling the characteristics of the solution comprising one or more populations of nucleic acid molecules are described, for clarity and brevity of description, using fluorophores that emit light in a wavelength characteristics thereto in response to excitation by light having suitable characteristics as an example of reporter molecules. However, the fluorophores serve as a non-limiting example of a suitable reporter molecule in this regard.

In general, the solution under study may be provided with any reporter molecule that changes one or more of its measurable properties when its binding status changes. As another example in this regard, a reporter molecule that changes its electro-chemical potential in dependence of its binding status may be applied. Consequently, the melt curve data may be represented by a signal descriptive of the electro-chemical potential measured from the solution as a function of temperature. As a further example, a reporter molecule that changes thermal energy emitted therefrom in dependence of its binding status may be applied. Consequently, the melt curve data may be represented by a signal descriptive of the thermal energy emitted by the solution as a function of temperature. As a yet further example, a reporter molecule that changes the mass of the reporter-target complex in dependence of its binding status may be applied. Consequently, the melt curve data may be represented by a signal descriptive of the weight of the reporter-target complex as a function of temperature.

Usage of fluorophores may be combined with usage of reporter molecules of different type in a manner similar to employing fluorophores of two or more different types. If, for example, applying both fluorophores and marker molecules changing their electro-chemical potential in dependence of their binding status, it is possible to obtain a first melt curve represented by a fluorescence signal descriptive of the light emitted by the solution under study as a function of temperature and a second melt curve represented by a signal descriptive of the electro-chemical potential of the solution under study as a function of temperature, both melt curves serving as a representation of the melt curve data and hence facilitating analysis of the melt behavior in a manner more accurate and reliable compared to the case of relying of only a single type of reporter molecules.

Returning to the fluorophores as an example of the reporter molecules, in view of the above-described characteristics of the nucleic acid molecules and the fluorophores and the relationship(s) therebetween, a fluorescence signal F(T) representing the melt curve data a given temperature may be modeled according to

F(T)=F₀(T)+Σᵢ₌₁^{N}^{_{tgt}}Fᵢ(T), (12)

wherein the parameter F₀(T) represents the fluorescence of, e.g. the combined intensity of the light emitted by, the unbound fluorophores in the solution under study at temperature T and the parameters Fᵢ(T) represent the fluorescence of, e.g. the combined intensity of the light emitted by, the fluorophores bound to the nucleic acid molecules of population i at temperature T. In other words, the parameter F₀(T) may be considered to represent the light emitted by the population of unbound fluorophores, whereas the parameters Fᵢ(T) may be considered to represent the light emitted by the population of fluorophores bound to the molecules of the nucleic acid molecule population i, the equation (12) thereby estimating or representing the fluorescence signal F(T) as a sum of two or more signal components. Hence, the equation (12) models the fluorescence signal descriptive of the overall melt curve at a given temperature as a sum of the first signal component representing the combined light intensity emitted by the unbound fluorophores at the given temperature and a set of second signal components, each second signal component representing the combined light intensity emitted by the fluorophores bound to the nucleic acid molecules of respective population at the given temperature. The equation (12) may be written as

F(T)=n₀(T)η_{0,tot}(T)+Σᵢ₌₁^{N}^{_{tgt}}nᵢ(T)η_{i,tot}(T), (13)

where the parameter n₀(T) represents the relative number of unbound fluorophores at temperature T, the parameters nᵢ(T) represent the relative number of fluorophores bound to the nucleic acid molecules of population i at temperature T, the parameter/function n_{0,tot}(T) represents the average emission efficiency of a single unbound fluorophore at temperature T and the parameters/functions η_{i,tot}(T) represent the average emission efficiency of a single fluorophore bound to the nucleic acid molecule of population i at temperature T. The equation (13) may be considered to provide the first signal component as a product of a first term n₀(T) and a second term n_{0,tot}(T) and to provide each second signal component as a product of the respective third term nᵢ(T) and the respective fourth term η_{i,tot}(T).

The number of unbound fluorophores n₀(T) and the numbers of fluorophores bound to the nucleic acid molecules nᵢ(T) are relative in that they do not necessarily need to indicate the actual respective number of fluorophores but is sufficient for the values of n₀(T) and nᵢ(T) to indicate the ratio of the actual number of unbound fluorophores and the actual number of fluorophores bound to each of the one or more nucleic acid molecule populations—or to put it another way, indicate the ratio of the actual number of unbound fluorophores and the actual number fluorophores bound to each of the one or more nucleic acid molecule populations in relation to the overall number of fluorophores nₜₒₜ. Consequently, as an example, the relative number of fluorophores nᵢ(T) bound to nucleic acid molecules of a first given population in relation to the relative number of fluorophores nⱼ(T) bound to nucleic acid molecules of a second given population serves as an indication of the concentration of the nucleic acid molecules of the first given population in the solution under study in relation to the nucleic acid molecules of the second given population.

As described hereinbefore, the emission efficiency of the fluorophores may be modeled by suitable function(s) of temperature, e.g. by ones according to the equations (1) or (2). If, as an example, assuming a model according to the equation (1) to represent the emission efficiency of the fluorophores, the equation (13) can be written as

F(T)=n₀(T)n₀e^{-T/τ}^{₀}+Σᵢ₌₁^{N}^{_{tgt}}nᵢ(T)ηᵢe^{-T/τ}^{ᵢ}. (14)

The equation (14) can hence be considered to provide an example of modeling the second term of the equation (13) by a parametric function that is descriptive of the emission efficiency of an unbound fluorophore as a function of temperature and to model each of the fourth terms of the equation (13) as a respective parametric function that is descriptive of the emission efficiency of a fluorophore bound to the respective nucleic acid molecule population as a function of temperature.

If further applying, as an example, a model that determines the occupancy level nᵢ(T)/Nᵢ(T) as a function of unbound fluorophores according to the equation (8), substituting the equation (9) into the equation (14) results in

F(T)=n₀(T)η₀e^{-T/τ}^{₀}+Σᵢ₌₁^{N}^{_{tgt}}Nᵢ(T)(1−e⁻ⁿ^{₀}^{(T)/γi})ηᵢe^{-T/τ}^{_{i,}} (15)

thereby eliminating the relative numbers of the fluorophores bound in each of the nucleic acid molecule populations nᵢ(T) from the equation. The equation (15) hence can be considered as an example of modeling each of the third terms of the equation (13) as a product of the overall number of binding locations for the respective population of nucleic acid molecules at a given temperature and a value of a parametric function that is descriptive of the occupancy level of said overall number of binding locations, which parametric function is a function of the relative number of unbound fluorophores in the solution.

Moreover, since the overall number of binding locations for a given nucleic acid molecule population may be modeled as described hereinbefore, it is possible substitute Nᵢ(T), for example, with the equation (5) to rewrite the equation (15) as

$$F ( T ) = {n}_{0} ( T ) {η}_{0} {e}^{- T / {τ}_{0}} + {\sum }_{i = 1}^{{N}_{tgt}} {N}_{i , 0} [ \frac{1}{2} - \frac{1}{2} erf ( \frac{T - {T}_{m , i}}{\sqrt{2 {σ}_{i}^{2}}} ) ] ( 1 - {e}^{- {n}_{0} ( T ) / {γ}_{i}} ) {η}_{i} {e}^{- T / {τ}_{i}} . \qquad ( 16 )$$

The equation (16) hence serves as an example of modeling the overall number of binding locations for a given population of nucleic acid molecules of the equation (15) as a parametric function that is descriptive of the melting probability of nucleic acid molecules of the respective population as a function of temperature.

The fluorescence signal F(T) representing the melt curve data as a function of temperature may be based on a plurality of measurements over the temperature range of interest, where the measured signal I(T) may involve inaccuracies and possible even measurement errors. As an example, the fluorescence signal F(T) may be derived on basis of equation (17).

I(T)=A·F(T)+B, (17)

where the term A is an adjustment factor and the term B is an offset, thereby providing an exemplifying model of linear distortions. The adjustment factor A and the offset B may be caused, for example, characteristics of the equipment employed for measuring the fluorescence signal F(T) such as photodetector properties, gain of possible amplifiers employed as part of the equipment, characteristics of analog-to-digital converters employed as part of the equipment, etc. Therefore, certain corrections and/or compensations may be carried out to compensate and/or minimize the effect of the distortions in the measured signal in order to derive the fluorescence signal F(T) on basis of the measured signal I(T). Consequently, due to corrections and/or compensations possibly affecting the absolute value(s) of the fluorescence signal F(T), the fluorescence signal F(T) subject to the modeling e.g. on basis of one of the equations (12) to (16) may be a normalized fluorescence signal Fₙₒᵣₘ(T). The normalization may involve e.g. setting the value of the normalized fluorescence signal Fₙₒᵣₘ(T) to a given reference value, e.g. to value one, at a given reference temperature and normalizing the rest of the values of the fluorescence signal F(T) accordingly, for example in accordance with equation (18).

Fₙₒᵣₘ(T=50° C.)=1,

$${F}_{norm} ( T ) = \frac{F ( T )}{F ( T = 50 ° C . )} . \qquad ( 18 )$$

Since it is typically sufficient to consider relative fluorescence across the temperature range of interest in order to determine relative concentrations of the nucleic acid molecule populations and/or temperature-dependent behavior of the employed fluorophores, applying the normalized fluorescence signal Fₙₒᵣₘ(T) instead of (the approximation of) the fluorescence signal F(T) obtained on basis of the corrections and/or compensations applied to the measured signal I(T) do not affect the outcome of the modeling in this regard.

Although described here in context of the equation (17), the normalization may be applied to any fluorescence signal, e.g. to one obtained on basis of a different, possibly non-linear, distortion model or even to one obtained by unknown derivation means. Moreover, the normalization may be carried using reference temperature different from the one exemplified in the equation (18) and/or by employing a different normalization scheme.

In view of the foregoing, the melt model described at a conceptual level by the equation (12) and further with various exemplifying further levels of detail in the equations (13) to (16) may be employed for melt curve analysis of a solution comprising one or more populations of nucleic acid molecules and a constant number of fluorophores of at least single type.

As an example, FIG. 9 depicts a flowchart illustrating a method 900 for analyzing a melt curve characterizing the melt of a solution comprising nucleic acid molecules of one or more types together with a constant number of fluorophores of at least first type. The method 900 comprises obtaining the fluorescence signal descriptive of melt curve data over a temperature range of interest, as indicated in step 910. The fluorescence signal represents the intensity of light emitted by the fluorophores of said first type as a function of temperature. The method 900 further comprises modeling the obtained fluorescence signal at a plurality of temperatures within the temperature range of interest in accordance with the melt model as described by one of the equations (13) to (16), as indicated in block 920. In other words, the melt model described by the equations (13) to (16) is applied to estimate or to represent the fluorescence signal. The method 900 further comprises utilizing numerical analysis to determine values of the terms of the applied melt model or parameters thereof to characterize respective components of the melt, as indicated in block 930. The method 900 may further comprise outputting the outcome of the numerical analysis e.g. by providing the results to be displayed on a display device of an apparatus or by providing the results for storage on a memory of an apparatus for subsequent further use in the apparatus or in another apparatus. Nonlimiting examples of functions, operations and/or procedures that may be applied to implement the processing indicated in blocks 910, 920 and 930 are described in the following.

Obtaining the fluorescence signal (block 910) may comprise, for example, reading a pre-composed fluorescence signal from a storage device, e.g. from a memory of a computer. As another example, obtaining the fluorescence signal may comprise exposing the solution under study to a plurality of temperatures within the temperature range of interest while at the same time exciting the solution with a light at a suitable wavelength in order to cause the fluorophores therein to emit light at a wavelength that is characteristics of the type of the employed fluorophores and to capture a signal representing the light so emitted as the fluorescence signal descriptive of the melt curve data. As a further example, the fluorescence signal may be obtained by converting a source signal of another type that is also descriptive of melt curve data into a fluorescence signal that (directly) represents the intensity of the light emitted by said fluorophores as a function of temperature. As an example, the fluorescence signal may be derived on basis of a signal descriptive of the negative first derivative of the melt curve as function of temperature. Such a source signal may be available as a result of a melt analysis since it conveniently indicates the (average) melting temperature as a peak in the signal.

Modeling the obtained fluorescence signal (block 920) may comprise modeling the fluorescence signal at each of the plurality of temperatures e.g. according to the equation (12) as a sum of a first signal component representing the combined light intensity emitted by the unbound fluorophores of said first type in the solution at a given temperature and a set of one or more second signal components, each second signal component representing the combined light intensity emitted by said fluorophores bound to the respective population of nucleic acid molecules at said given temperature. In accordance with the equation (13) the first signal component may be provided as a product of a first term that represents the relative number of unbound fluorophores of said first type at said given temperature and a second term that represents the emission efficiency of an unbound fluorophore of said first type at said given temperature. Each of the second signal components is provided as a product of a respective third term that represents the relative number of said fluorophores bound to the respective population of nucleic acid molecule at said given temperature and a respective fourth term that represents the emission efficiency of said fluorophores bound to the respective population of nucleic acid molecules at said given temperature. Moreover, the second term of the melt model according to the equation (13) may be further modeled e.g. according to a parametric function in accordance with the equations (1) or the equation (2), each of the third terms according to the equation (13) may be further modeled e.g. according to the equation (9) and possibly further e.g. by the equation (5) or the equation (7), depending on the intended application of the melt model and possible a priori knowledge regarding the values of the terms and/or parameters of the melt model.

Utilizing numerical analysis (block 930) may comprise utilizing numerical analysis to determine the values of said first term, said second term, each of said third terms and each of said fourth terms at said plurality of temperatures such that the difference between the obtained fluorescence signal and the modeled fluorescence signal meets a predefined criterion. The difference between the obtained fluorescence signal and the modeled fluorescence signal meeting the predefined criterion may comprise e.g. the difference minimizing a cost function. In case the fluorescence signal is directly modeled on basis of the equation (13), the values of the first, second, third and fourth terms at said plurality of temperatures may be directly determined. In case the fluorescence signal is modeled e.g. on basis of one of the equations (14) to (16) where one or more of the second, third and fourth terms may be modeled on basis of respective parametric functions, determining values for terms represented by one or more parametric functions may comprise determining the parameter values of the respective parametric functions.

In some scenarios the values of one or more parameters of the melt model are known in advance. Consequently, the utilization of numerical analysis to determine the values of the first, second, third and fourth terms of the melt model may comprise setting at least one of said terms to respective predetermined values at plurality of temperatures within the temperature range of interest and employing numerical analysis to determine values of the other terms of the melt model at said plurality of temperatures. This hence implies substituting the predetermined values of terms and/or parameters in the melt model and applying numerical analysis to derive the values of the remaining unknown terms and/or parameters.

The method 900 may further be applied to analyze the melt curve characterizing the melt of a solution that further comprises a constant number of fluorophores of a second type. For such application the method 900 may further comprise applying the processing described in context of block 910 in order to obtain a second fluorescence signal representing the intensity of light emitted by fluorophores of the second type, applying the processing described in context of block 920 to model the second fluorescence signal by employing an approach similar to that applied for the (first) fluorescence signal, and applying the processing described in context of block 930 to utilize numerical analysis to determine the values of the first term, the second term, each of the third terms and each of the fourth terms of the melt model such that the difference between the obtained second fluorescence signal and the respective modeled fluorescence signal meets the predefined criterion. Consequently, e.g. the set of determined values for the first, second, third and fourth terms either determined on basis of the fluorophores of the first type or on basis of the fluorophores of the second type may be selected to represent the melt of the solution, whichever provides better match with the respective fluorescence signal.

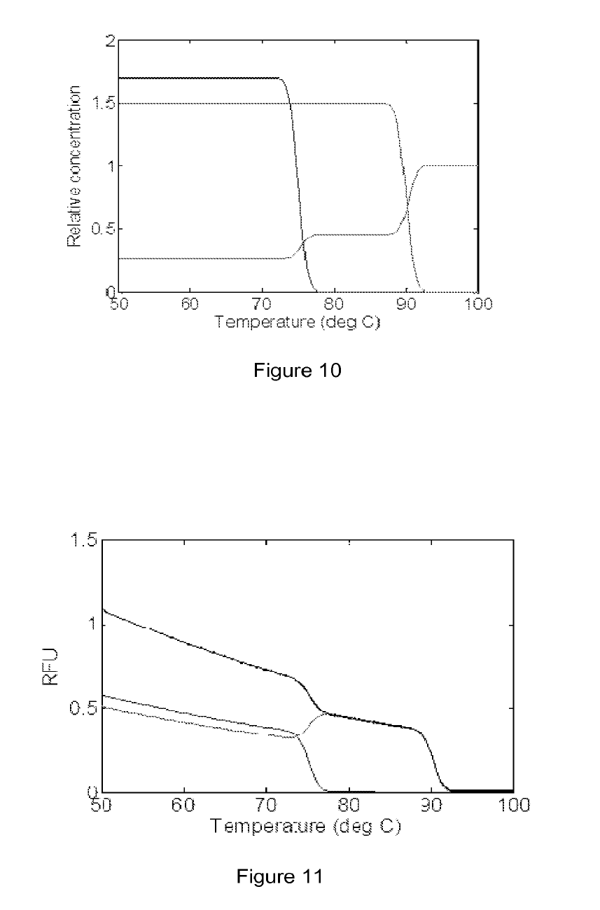

In the following, an example of the computation of the characteristics of the melt on basis of the melt model e.g. in context of the exemplifying method 900 is provided by describing a single computation or simulation round.
a) A simulation/computation round commences by setting all parameters of the employed version of the melt model to desired values. If, for example, applying the melt model according to the equation (16), the total number of fluorophores nₜₒₜ, the parameters descriptive of the emission characteristics of the unbound fluorophores (η₀, τ₀), the parameters descriptive of the emission characteristics of fluorophores bound to each population of nucleic acid molecules (γᵢ, ηᵢ, τᵢ), the melt parameters for each population of nucleic acid molecules (T_{m,i}, σ₁, N_{i,0}) as well as the overall number of nucleic acid molecule populations (N_{tgt}) are set to desired values.
b) As the first computation step of numerical analysis according to this example, the overall number of binding locations as a function of temperature Nᵢ(T) within the temperature range of interest is determined. This may be carried out, for example, on basis of the equation (5). As an example in this regard, FIG. 10 illustrates curves descriptive of relative overall numbers of binding locations Nᵢ(T) for a solution including two populations of nucleic acid molecules (labeled ‘Target 1’ and ‘Target 2’, i.e. N_{tgt}=2), where the melt parameters for the two populations of nucleic acid molecules are T_{m,1}=75° C., T_{m,2}=90° C., σ₁=τ₂=1° C., N_{1,0}=1.7, N_{2,0}=1.5.

c) As the following step of the example, the computed overall numbers of binding locations Nᵢ(T) for each of the nucleic acid molecule populations are employed, together with the knowledge of the fact that the overall number of fluorophores in the solution nₜₒₜ remains constant regardless of the temperature (see the equation (3)), to compute the number of unbound fluorophores n₀(T) on basis of the equation (10). Although the number of unbound fluorophores n₀(T) cannot in general case be solved on basis of the equation (10) using analytical methods, numerical methods known in the art, such as Newton iteration, can be employed to determine n₀(T). Consequently, with the knowledge of the values of nₜₒₜ, Nᵢ(T), N_{tgt}, and γᵢ the values of the nᵢ(T) may be solved e.g. on basis of the equation (9). As an example in this regard, FIG. 10 further illustrates a curve descriptive of the relative number of unbound fluorophores as a function of temperature n₀(T).
d) As the final step in this example, the first signal component F₀(T), the second signal components Fᵢ(T) and the resulting modeled fluorescence signal F(T) are determined. This can be done since also the parameters descriptive of the emission characteristics (η₀, τ₀, ηᵢ, τᵢ) are set to desired values, the respective emission efficiencies may be determined e.g. on basis of the equation (1) and modeled fluorescence signal components F₀(T) and Fᵢ(T) may be derived according to the equation (14). As an example in this regard, the modeled fluorescence signal F(T) may be compared to the obtained fluorescence signal and the difference or similarity therebetween may be evaluated by using a suitable predefined cost function. FIG. 11 illustrates the signal components Fᵢ(T) representing the combined intensity of light emitted by each of the two populations of nucleic acid molecules of this example (labeled ‘Target 1’ and ‘Target 2’) together with their sum (‘Measured signal’), where the melt parameters for the two populations of nucleic acid molecules are the same as in context of FIG. 10 and the parameters descriptive of the emission characteristics are τ₀=50° C.⁻¹, η₀=0.01, γ₁=γ₂=1, η₁=η₂=1, τ₁=τ₂=50° C.⁻¹.

In the above example, the desired parameter values set in step a) may represent known and hence predetermined values for the respective terms and/or parameters of the melt model, and hence a single simulation/computation round through a) to d) may be sufficient to determine the values for the remaining terms and/or parameters.

As another example, some of the desired parameter values set in step a) may be known and hence predetermined parameter values for the respective terms and/or parameters of the melt model, while the other desired parameter values are candidate values for unknown terms and/or parameter values applied for a given simulation/computation round. Therefore, a number of simulation/computation rounds through a) to d) may be required to test all desired combinations of candidate values while keeping the known parameters at their predetermined values throughout the simulation rounds in order to evaluate the match between the respective modeled fluorescence signal F(T) and the observed fluorescence signal. Once all desired combinations have been simulated, the combination of (the predetermined parameter values and) the candidate values resulting in the best match between the modeled fluorescence signal F(T) and the observed fluorescence signal are chosen to represent the melt.

As an example in this regard, the parameters descriptive of the emission characteristics (η₀, τ₀, ηᵢ, τᵢ) may have known and hence predetermined values throughout the simulation rounds, while the rest of the parameters, including the melt parameters for each population of nucleic acid molecules (T_{m,i}, σᵢ, N_{i,0}) as well as the overall number of nucleic acid molecule populations N_{tgt} may have unknown values to be determined by the simulation. As another example in this regard, the melt parameters for each population of nucleic acid molecules (T_{m,i}, σᵢ, N_{i,0}) as well as the overall number of nucleic acid molecule populations N_{tgt} and their relative concentrations may have known and hence predetermined values throughout the simulation rounds, whereas the parameters descriptive of the emission characteristics (η₀, τ₀, ηᵢ, τᵢ) may have unknown values to be determined by the simulation. In a further example scenario all parameters of the melt model may be considered as unknown parameters, possibly requiring a high number of simulation/computation rounds.

In a scenario where a number of the terms or parameters of the melt model have unknown values, it may be advantageous to limit the range and/or number of respective candidate values in order to reduce the complexity of the analysis process and to increase the likelihood of ending up with a correct and meaningful result. The candidate values may be selected e.g. on basis of a priori knowledge of typical values under the circumstances. As another example, the characteristics of the observed fluorescence signal or melt curve data in general may be used to select a suitable range of candidate values e.g. for the melting temperatures T_{m,i} and the melt widths σᵢ. If, as a concrete example, assuming an overall melt curve illustrated in FIG. 1, one can see that due to the steep decrease in the overall melting curve it seems likely that melting of one or more populations of nucleic acid molecules occurs at and around 75° C. and further that melting of one or more populations of nucleic acid molecules occurs at and around approximately 90° C. Therefore, the numerical analysis may be limited to e.g. consider only values for the parameters T_{m,i} and σᵢ that are within suitable temperature subranges around 75° C. and around 90° C. together with appropriate respective values of N_{i,0} and by assuming 1, 2, . . . , Nₘₐₓ populations of nucleic acid molecules melting at both temperature subranges in order to avoid consideration of values for these parameters that appear unlikely to provide a proper model with the observed fluorescence signal anyway.

A practical example where melt curve analysis in accordance with embodiments of the invention may be used is a typical SNP detection scenario where the sample under study can be either homozygous or heterozygous for the SNP of interest. In homozygous case both copies of the target in the genome are identical in the region of interest and the target DNA consists of two complementary strands. In heterozygous case there are two different types of sequence in the region of interest. Initially when the heterozygous sample is unamplified these two different sequences both consist of complementary strands, but after denaturation and/or amplification these four different strands can pair also in mismatched manner resulting in two original homoduplexes and two newly created heteroduplexes. It is typical that both heteroduplexes have significantly lower Tₘ than either of the original homoduplexes. Thus it is possible that when two different heteroduplexes melt the four separated strands could form two homoduplexes. In terms of the melt curve analysis in accordance with embodiments of the invention this implies that when two separate populations of heteroduplex nucleic acids melt, the freed single stranded nucleic acid chains may form two new types of homoduplex nucleic acid populations with respective binding locations. Thus, the number of targets N_{tgt} and the respective populations of said targets may change when the temperature changes. The melt curve analysis in accordance with embodiments of the invention may take this shift from a population to another into account if necessary.

The numerical analysis applied in context of the exemplifying method 900 e.g. to implement one or more simulation/computation rounds through a) to d) may basically apply any method of numerical analysis known in the art. Non-limiting examples of applicable methods include, Levenberg-Marquardt algorithm, also known as the damped least-squares method, Gauss-Newton algorithm, gradient descent method, Nelder-Mead method, conjugate gradient method, random search method, etc.

The temperature range of interest in application of the model according to any of the equations (12) to (16) preferably covers the temperatures from a lower end of the temperature range below melting of the any of the nucleic acid molecule populations in the solution under study up to an upper end of the temperature range that is higher than the melting temperature of any of the nucleic acid molecule populations of the solution under study. A temperature range extending from 50° C. up to 100° C. is typically sufficient to cover the analysis of the melting behavior of nucleic acid molecule populations of interest. However, a temperature range extending to temperatures lower than 50° C. and/or to temperatures higher than 100° C. may be applied. Alternatively, a more focused temperature range of interest may be applied in view of advance knowledge of the melting behavior. In this regard, the temperature range of interest usually covers at least the portions of steep decrease of the overall melt curve typically indicating melting of one or more nucleic acid molecule populations in order to guarantee capturing the full melting behavior and hence the situation before essentially any melting in the solution under study has taken place to enable determining the initial relative concentrations of the nucleic acid molecule populations comprised in the solution.

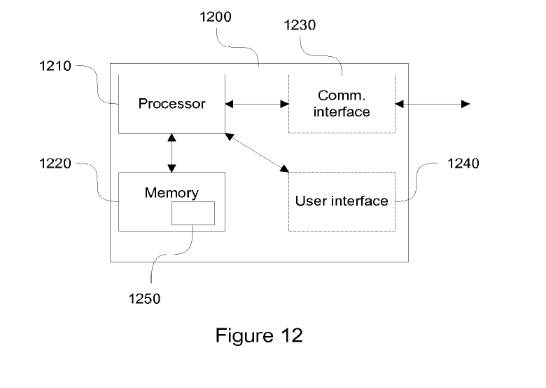

As a non-limiting further example, FIG. 12 schematically illustrates an exemplifying apparatus 1200 that may be employed for embodying the melt curve analysis method 900 described hereinbefore or variations thereof. The apparatus 1200 comprises a processor 1210 and a memory 1220, the processor 1210 being configured to read from and write to the memory 1220. The apparatus 1200 may further comprise a communication interface 1230, such as a network card or a network adapter enabling wireless or wired communication with one or more another apparatuses. The apparatus 1200 may further comprise a user interface 1240 for providing data, commands and/or other input to the processor 1210 and/or for receiving data or other output from the processor 1210, the user interface 1240 comprising for example one or more of a display, one or more keys, a keyboard, a mouse or a respective pointing device, a touchscreen, etc. The apparatus 1200 may comprise further components not illustrated in the example of FIG. 12.

Although the processor 1210 is presented in the example of FIG. 12 as a single component, the processor 1210 may be implemented as one or more separate components. Although the memory 1220 is illustrated as single component, the memory 1220 may be implemented as one or more separate components, some or all of which may be integrated/removable and/or may provide permanent/semi-permanent/dynamic/cached storage.

The apparatus 1200 may be embodied as a special-purpose or as a general purpose device with a sufficient processing capacity. Alternatively, the apparatus 1200 may be embodied as an apparatus dedicated for implementing the melt curve analysis method(s) described hereinbefore or variations thereof and possibly method(s) or function(s) related to the melt curve analysis.

The memory 1220 may store a computer program 1250 comprising computerexecutable instructions that control the operation of the apparatus 1200 when loaded into the processor 1210 and executed by the processor 1210. As an example, the computer program 1250 may include one or more sequences of one or more instructions. The computer program 1250 may be provided as a computer program code. The processor 1210 is able to load and execute the computer program 1250 by reading the one or more sequences of one or more instructions included therein from the memory 1220. The one or more sequences of one or more instructions may be configured to, when executed by one or more processors, cause an apparatus, for example the apparatus 1200, to implement the melt curve analysis method(s) described hereinbefore or variations thereof.

Hence, the apparatus 1200 may comprise at least one processor 1210 and at least one memory 1220 including computer program code for one or more programs, the at least one memory 1220 and the computer program code configured to, with the at least one processor 1210, cause the apparatus 900 to perform the melt curve analysis method(s) described hereinbefore or variations thereof.

The computer program 1250 may be provided independently of the apparatus, and the computer program 1250 may be provided at the apparatus 1200 via any suitable delivery mechanism. As an example, the delivery mechanism may comprise at least one computer readable non-transitory medium having program code stored thereon, the program code which when executed by an apparatus cause the apparatus at least implement processing to carry out the melt curve analysis method(s) described hereinbefore or variations thereof.

The delivery mechanism may be for example a computer readable storage medium, a computer program product, a memory device a record medium such as a CD-ROM, a DVD, a corresponding optical media, an article of manufacture that tangibly embodies the computer program 1250, etc. As a further example, the delivery mechanism may be a signal configured to reliably transfer the computer program 1250.

Reference to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

As an example, embodiments of the invention could be applied to facilitate genotyping for variants in a particular area of genome known to be relevant for diagnosis or prognosis of cancer. A sample DNA would preferably be purified, after which a region or a part of it would be amplified by using for example PCR. The PCR step could be optimized to occur even in the presence of dsDNA binding fluorophore, enabling monitoring the amplification in real time, detecting failed amplification for internal quality control, and melting analysis without the need to open the tube for any further reagent addition. After the PCR step the amplified products would be analyzed, possibly in the same instrument, by running a melt curve analysis technique. As characteristics of the dye used would be known, melt curve analysis in accordance with embodiments of the present invention provide a powerful tool for identifying the number of different molecules and their proportions in the amplified sample. In addition to identifying presence of previously known mutant variants, melt curve analysis in accordance with embodiments of the present invention may also be applied to find previously unknown variants that might also be of relevance. While typically all such samples showing signs of any variations would have to be confirmed with another technique such as sequencing, for example in case of screening a high number of samples including only a few that have any variations, melt curve analysis in accordance with embodiments of the present invention is likely to enable cost savings as the number of samples to be sequenced could be significantly reduced.

Melt curve analysis in accordance with embodiments of the present invention also enables melt curve based quantification of targets. As an example, a method based on amplification efficiencies being the same for amplicons amplified in the same reaction with same primers and having almost the same sequence has been described more thoroughly in publication WO2010/128206A1. In this method the target is mixed with a known amount of fragment that has almost the same sequence. After amplification, relative amounts of both targets are assessed by analyzing the melt curve data. In WO2010/128206A1 melting peaks have to be relatively well separated in order to allow traditional melt curve analysis methods to fit melting peaks for both targets. Also a standard series of known ratios of targets are required to calibrate the analysis system. When using melt curve analysis in accordance with embodiments of the present invention for the analysis instead, melting points of the targets with related sequence can be much closer to each other allowing easier design of the assay. It is also beneficial for the method of WO2010/128206A1 to have sequences as similar as possible because the similarity ensures equal amplification efficiencies for these two targets, i.e. similar amplification efficiency is critical for the assay. Applying melt curve analysis in accordance with embodiments of the present invention for the quantification would also eliminate the requirement of running standard series for every different type of assay.

1. A method for analyzing a melt curve characterizing the melt of a solution comprising one or more populations of nucleic acid molecules and a constant number of fluorophores of at least first type, the method comprising
obtaining a fluorescence signal descriptive of melt curve data over a temperature range, the fluorescence signal representing the intensity of the light emitted by said fluorophores as a function of temperature,
modeling the fluorescence signal at a plurality of temperatures within the temperature range as a sum of a first signal component representing the combined light intensity emitted by unbound fluorophores of said first type in the solution at a given temperature and a set of one or more second signal components, each representing the combined light intensity emitted by said fluorophores bound to the respective nucleic acid molecule population at the given temperature,
wherein the first signal component is provided as a product of a first term representing the relative number of unbound fluorophores of said first type at the given temperature and a second term representing the emission efficiency of an unbound fluorophore of said first type at said given temperature, and
wherein each second signal component is provided as a product of a respective third term representing the relative number of said fluorophores bound to the respective nucleic acid molecule population at the given temperature and a respective fourth term representing the emission efficiency of said fluorophore bound to the respective nucleic acid molecule population at said given temperature, and
utilizing numerical analysis to determine the values of said first, second, third and fourth terms at said plurality of temperatures such that the difference between the fluorescence signal and the modeled fluorescence signal meets a predefined criterion.

2. A method according to claim 1, wherein modeling the fluorescence signal further comprises
modeling each of said third terms as a product of the overall number of binding locations for the respective nucleic acid molecule population at said given temperature and the value of a first parametric function that is descriptive of the occupancy level of said overall number of binding locations as a function of the relative number of unbound fluorophores in the solution
wherein said overall number of binding locations is determined by a second parametric function that is descriptive of the melting probability of the respective nucleic acid molecule population as a function of temperature, and
wherein determining the values for each of said third terms comprises determining parameter values of said first and second parametric functions.

3. A method according to claim 2, wherein said second parametric function is a function exhibiting a sigmoid shape.

4. A method according to claim 3, wherein said second parametric function is defined as
$${N}_{i , 0} [ \frac{1}{2} - \frac{1}{2} erf ( \frac{T - {T}_{m , i}}{\sqrt{2 {σ}_{i}^{2}}} ) ] ,$$
wherein T represents the given temperature, the parameters N_{i,0} represent the overall number of binding locations of the respective nucleic acid molecule population before essentially any melting has taken place, the parameters T_{m,i} represent the average melting temperature for the respective nucleic acid molecule population and the parameters σᵢ represent melt width for the respective nucleic acid molecule population, and wherein erf(x) is the error function.

5. A method according to claim 2, wherein said first parametric function is defined as
1−e⁻ⁿ^{ₒ}^{/γi},
wherein n₀ indicates the relative number of unbound fluorophores of said first type in the solution and the parameters γᵢ represent the fill balance coefficient for the respective nucleic acid molecule population.

6. A method according to claim 1, wherein modeling the fluorescence signal further comprises
modeling said second term by a third parametric function that is descriptive of the emission efficiency of an unbound fluorophore of said first type as a function of temperature, and
modeling each of said fourth terms by a respective fourth parametric function that is descriptive of the emission efficiency of said fluorophore bound to the respective nucleic acid molecule population as a function of temperature,
wherein determining the values for said second term comprises determining parameter values of said third parametric function and wherein determining the values for each of said fourth terms comprises determining parameter values for the respective fourth parametric function.

7. A method according to claim 6, wherein said third parametric function is defined as
η₀e^{-T/τ}^{₀},
wherein the parameter η₀ represents a relative reference emission efficiency of an unbound fluorophore of said first type, T represents the given temperature and the parameter τ₀ represents a temperature decay coefficient for an unbound fluorophore of said first type, and
wherein said fourth parametric functions are defined as
ηᵢe^{-T/τ}^{ᵢ},
wherein the parameters ηᵢ represent a relative reference emission efficiency of said fluorophore bound to the respective nucleic acid molecule population, T represents the given temperature and the parameters τᵢ represent a temperature decay coefficient for said fluorophore bound to the respective nucleic acid molecule population.

8. A method according to claim 1, wherein utilizing numerical analysis comprises
setting at least one of said terms to predetermined values at said plurality of temperatures, and
employing numerical analysis to determine values of the other terms at said plurality of temperatures.

9. A method according to claim 8,
wherein said setting comprises setting said second term and each of said fourth terms to respective predetermined values, and
wherein said employing comprises employing numerical analysis to determine values of the first term and each of said third terms to enable determination of relative concentrations and/or characteristics of the one or more nucleic acid molecule populations in the solution.

10. A method according to claim 8,
wherein said setting comprises setting said first term and each of said third terms to respective predetermined values, and
wherein said employing comprises employing numerical analysis to determine values of the second term and each of said fourth terms to enable determination of characteristics of the fluorophores of said first type.

11-14. (canceled)

15. An apparatus for analyzing a melt curve characterizing the melt of a solution comprising one or more populations of nucleic acid molecules and a constant number of fluorophores of at least first type, the apparatus comprising at least one processor and at least one memory including computer program code for one or more programs, the at least one memory and the computer program code configured to, with the at least one processor, cause the apparatus to perform at least the following:
obtain a fluorescence signal descriptive of melt curve data over a temperature range, the fluorescence signal representing the intensity of the light emitted by fluorophores of said first type as a function of temperature,
model the fluorescence signal at a plurality of temperatures within the temperature range as a sum of a first signal component representing the combined light intensity emitted by unbound fluorophores of said first type in the solution at a given temperature and a set of one or more second signal components, each representing the combined light intensity emitted by said fluorophores bound to the respective nucleic acid molecule population at the given temperature,
wherein the first signal component is provided as a product of a first term representing the relative number of unbound fluorophores of said first type at the given temperature and a second term representing the emission efficiency of an unbound fluorophore of said first type at said given temperature, and
wherein each second signal component is provided as a product of a respective third term representing the relative number of said fluorophores bound to the respective nucleic acid molecule population at the given temperature and a respective fourth term representing the emission efficiency of said fluorophore bound to the respective nucleic acid molecule population at said given temperature, and
utilize numerical analysis to determine the values of said first, second, third and fourth terms at said plurality of temperatures such that the difference between the first fluorescence signal and the modeled fluorescence signal meets a predefined criterion.

16. An apparatus according to claim 15, wherein modeling the fluorescence signal further comprises
modeling each of said third terms as a product of the overall number of binding locations for the respective nucleic acid molecule population at said given temperature and the value of a first parametric function that is descriptive of the occupancy level of said overall number of binding locations as a function of the relative number of unbound fluorophores in the solution
wherein said overall number of binding locations is determined by a second parametric function that is descriptive of the melting probability of the respective nucleic acid molecule population as a function of temperature, and
wherein determining the values for each of said third terms comprises determining parameter values of said first and second parametric functions.

17. An apparatus according to claim 16, wherein said second parametric function is a function exhibiting a sigmoid shape.

18. An apparatus according to claim 17, wherein said second parametric function is defined as
$${N}_{i , 0} [ \frac{1}{2} - \frac{1}{2} erf ( \frac{T - {T}_{m , i}}{\sqrt{2 {σ}_{i}^{2}}} ) ] ,$$
wherein T represents the given temperature, the parameter N_{i,0} represent the overall number of binding locations of the respective nucleic acid molecule population before essentially any melting has taken place, the parameters T_{m,i} represent the average melting temperature for the respective nucleic acid molecule population and the parameters σᵢ represent melt width for the respective nucleic acid molecule population, and wherein erf(x) is the error function.

19. An apparatus according to claim 17, wherein said first parametric function is defined as
1−e⁻ⁿ^{₀}^{/γi},
wherein n₀ indicates the relative number of unbound fluorophores of said first type in the solution and the parameters γᵢ represent the fill balance coefficient for the respective nucleic acid molecule population.

20. An apparatus according to claim 15, wherein modeling the fluorescence signal further comprises
modeling said second term by a third parametric function that is descriptive of the emission efficiency of an unbound fluorophore of said first type as a function of temperature,
modeling each of said fourth terms by a respective fourth parametric function that is descriptive of the emission efficiency of said fluorophore bound to the respective nucleic acid molecule population as a function of temperature, and
wherein determining the values for said second term comprises determining parameter values of said third parametric function and wherein determining the values for each of said fourth terms comprises determining parameter values for the respective fourth parametric function.

21. An apparatus according to claim 20, wherein said third parametric function is defined as
η₀e^{-T/τ}^{₀},
wherein the parameter η₀ represents a relative reference emission efficiency of an unbound fluorophore of said first type, T represents the given temperature and the parameter τ₀ represents a temperature decay coefficient for an unbound fluorophore of said first type, and
wherein said fourth parametric functions are defined as
ηᵢe^{-T/τ}^{ᵢ},
wherein the parameters ηᵢ represent a relative reference emission efficiency of said fluorophore bound to the respective nucleic acid molecule population, T represents the given temperature and the parameters τᵢ represent a temperature decay coefficient for said fluorophore bound to the respective nucleic acid molecule population.

22. An apparatus according to claim 15, wherein utilizing numerical analysis to determine the values of said first, second, third and fourth terms comprises
setting at least one of said terms to predetermined values at said plurality of temperatures, and
employing numerical analysis to determine values of the other terms at said plurality of temperatures.

23. An apparatus according to claim 22,
wherein said setting comprises setting said second term and each of said fourth terms to respective predetermined values, and
wherein said employing comprises employing numerical analysis to determine values of the first term and each of said third terms to enable determination of relative concentrations and/or characteristics of the one or more nucleic acid molecule populations in the solution.

24. An apparatus according to claim 22,
wherein said setting comprises setting said first term and each of said third terms to respective predetermined values, and
wherein said employing comprises employing numerical analysis to determine values of the second term and each of said fourth terms to enable determination of characteristics of the fluorophores of said first type.
